(19) United States
(12) Patent Application Publication
(10) Pub. No.: US 2006/0012724 A1
(43) Pub. Date: Jan. 19, 2006

(54) Color calibrator for flat panel display and method thereof

(76) Inventor: Cheol-Woo Park, Kyungki-do (KR)

Correspondence Address: MCGUIREWOODS, LLP, 1750 TYSONS BLVD, SUITE 1800, MCLEAN, VA, 22102, US

(21) Appl. No.: 10/518,786

(22) PCT Filed: Sep. 18, 2002
(86) PCT No.: PCT/KR02/01768

§ 371 Date: Aug. 15, 2005

(30) Foreign Application Priority Data
Jun. 21, 2002 (KR) 2002/34905

(51) Int. Cl. H04N 9/69

(52) U.S. Cl. 348/791; 348/675

(57) ABSTRACT

The present invention relates to a device and a method of color correction for a flat panel display capable of realizing color productivity compared to CRT, a broadcasting standard. The present invention divides the color coordinates of received image signals into nine subareas before color correction and stores a plurality of conversion distance information obtained by matching the divided subareas with divided subareas for reference color coordinates and corrected values for the image signals. Subsequently, the present invention converts the image signals by converting the conversion distance information by using interpolation and extracts the corrected values depending on the converted image signals to correct the image signals. Accordingly, the flat panel display according to the embodiments of the present invention displays standard broadcasting image signals with color reproductivity to a maximum color range that the flat panel display can reproduce but without distorting colors.

### BACKGROUND OF THE INVENTION

(a) Field of the Invention

The present invention relates to a device and a method of color correction of image signals, and in particular, to a device and a method of color correction for a flat panel display.

(b) Description of the Related Art

Since cathode ray tubes (CRTs) have been only one dominating color display, the colors for displaying image signals could be standardized by the standard fluorescent material specification for CRT and red (R), green (G) and blue (B) signal standard or cyan (Cy), magenta (Ma) and yellow (Ye) signal standard based on the standard fluorescent material specification for CRT. However, recent growth of next-generation flat panel displays (FPDs) such as liquid crystal display (LCD), plasma display panel (PDP), electro luminescent display (ELD) and field emission diode (FED) increases the market size as large as that of CRT, and their applications are enlarged to television sets beyond notebook PC (personal computer) and monitor.

In order to enter into the TV market leaded by the CRT, the FPD such as LCD has some technical problems to be overcome such as color reproductivity and color standardization. Although recent development of color filter technique for the LCD reaches the color productivity compared to that of the CRT, the standard colors for the LCD are different from those of the CRT and thus the LCD may not avoid displaying colors somewhat different from those expected according to the broadcasting signals based on the CRT.

FPDs including LCD generally suffer from the problem. That is, in a conventional color coordinate system such as CIE (Commission Internationale de l'Eclairage) system, the colors on the FPDs are different from the colors on the CRT which is a standard for NTSC (national television system committee) method or PAL (phase alternation line) system.

In order to reduce the color difference, it is suggested that the colors are represented in a triangle having three apexes in a color coordinate system, the apexes formed by intersections of lines from a center white point to apexes of a triangle indicating CRT standard broadcasting colors and a triangle indicating flat panel display colors. However, this reduces the available ranges of colors which can be realized by the FPDs and thus deteriorates the color reproductivity.

### SUMMARY OF THE INVENTION

Therefore, it is a motivation to provide a flat panel display having color reproductivity without color distortion when displaying image signals in broadcasting standard.

A color corrector of a flat panel display according to an embodiment of the present invention includes: a look-up table storing a plurality of convertation distance information obtained by matching nine divided subareas for color coordinates of received image signals with divided subareas for reference color coordinates and corrected values for the image signals; and a color correction unit converting the image signals by converting the convertation distance information by using interpolation, and extracts the corrected values depending on the converted image signals to correct the image signals.

A method of color correction for a flat panel display using a color corrector of the flat panel display for correcting image signals in broadcasting standard into image signal for driving the flat panel display is provided, the method includes: (a) extracting gray values for apexes on reference color coordinates for received image signals; (b) comparing the gray values for the reference color coordinates of the standard broadcasting image signals and the reference color coordinates of the flat panel display, diving the color coordinates into nine subareas using an areal division, matching the divided subareas with divisional areas of the reference color coordinates, and extracting a conversion distance information; and (c) correcting the received standard broadcasting image signals by converting the conversion distance information using interpolation, and outputting image signals for driving the flat panel display.

The areal division preferably includes: (d) extracting line segments from a white point of the color coordinate to apexes of the reference color coordinates, and line segments from the white point of the color coordinate to internal divisions where extensions from the apexes meet the line segments of the reference color coordinates; (e) extracting line segments from the white point of the color coordinates to points where the two gray values become maximum; (f) extracting line segments from the points P, Q and S on the color coordinates where the two gray values become maximum to the apexes R, G and B of the reference color coordinates; and (g) dividing the area of each reference color coordinate into the nine subareas having boundaries of the extracted line segments.

The conversion distance information includes a gray value distance for line segments from apexes of the reference color coordinates to points where the gray values become maximum, and a gray value distance for line segments from internal divisions where extensions from white points of color coordinates to the apexes meet the line segments of the reference color coordinates to the apexes of the reference color coordinates.

The interpolation preferably includes:
(h-1) calculating Ri′, Gi′ and Bi′ for the coordinate values of the image signals Ri, Gi and Bi using an equation:
   (Ri′, Gi′, Bi′)=(Ri−min(Ri,Gi,Bi), Gi−min(Ri,Gi,Bi)−min(Ri,Gi,Bi));
(h-2) calculating K using an equation:

$$K = \frac{Max G}{max ( {Ri}^{′} , {Gi}^{′} , {Bi}^{′} )} ;$$
(h-3) calculating converted values Ri″, Gi″ and Bi″ using an equation:
   (Ri″, Gi″, Bi″)=(K×Ri′, K×Gi′, K×Bi′),
   where the converted value Ri″, Gi″ and Bi″ include 0, the maximum gray, and a number t which is neither 0 nor the maximum gray.
(h-4) calculating converted values Ro″, Go″ and Bo″ including 0, the maximum gray and a value for the gray values on the corresponding areas for the nine subareas depending on t forming the converted values Ri″, Gi″ and Bi″, the value obtained by one among:

$$\{ t - Max G \times \frac{n1}{m1 + n1} \} \times \frac{b}{a} , \qquad ( 4 )$$

where t is a number among Ri″, Gi″ and Bi″ except for 0 and the maximum gray, and m1, n1, a and b are the predetermined conversion distance information;

$$t \times \frac{f}{e} , \qquad ( 5 )$$

where t is a number among Ri″, Gi″ and Bi″ except for 0 and the maximum gray, and e and f are the predetermined conversion distance information; and

$$t \times \frac{c}{b} + Max G \times \frac{n2}{m2 + n2} , \qquad ( 6 )$$

where t is a number among Ri″, Gi″ and Bi″ except for 0 and the maximum gray, and a, b, m2 and n2 are the predetermined conversion distance information; and
(h-5) calculating the gray values Ro, Go and Bo of the image signals for driving the flat panel display using an equation:

$$( Ro , Go , Bo ) = \frac{( {Ro}^{″} , {Go}^{″} , {Bo}^{″} )}{K} + ( min ( Ri , Gi , Bi ) , min ( Ri , Gi , Bi ) , min ( Ri , Gi , Bi ) ) .$$

### BRIEF DESCRIPTION OF THE DRAWINGS

FIG. 1 is a block diagram of a color corrector for a flat panel display according to an embodiment of the present invention.

FIG. 2 illustrates an exemplary division of nine subareas in a color corrector of a flat panel display according to an embodiment of the present invention.

FIG. 3A illustrates an exemplary interpolation for color correction with three divided areas when a B gray is the highest in FIG. 2.

FIG. 3B illustrates an exemplary interpolation for color correction with three divided areas when a G gray is the highest in FIG. 2.

FIG. 3C illustrates an exemplary interpolation for color correction with three divided areas when a R gray is the highest in FIG. 2.

FIG. 4 is a flow chart illustrating an exemplary interpolation with a highest B gray in a color corrector of a flat panel display according to an embodiment of the present invention.

### DETAILED DESCRIPTION OF PREFERRED EMBODIMENTS

The present invention now will be described more fully hereinafter with reference to the accompanying drawings, in which preferred embodiments of the invention are shown. The present invention may, however, be embodied in many different forms and should not be construed as limited to the embodiments set forth herein.

Now, color correctors for a flat panel display and methods thereof according to embodiments of the present invention will be described with reference to the drawings.

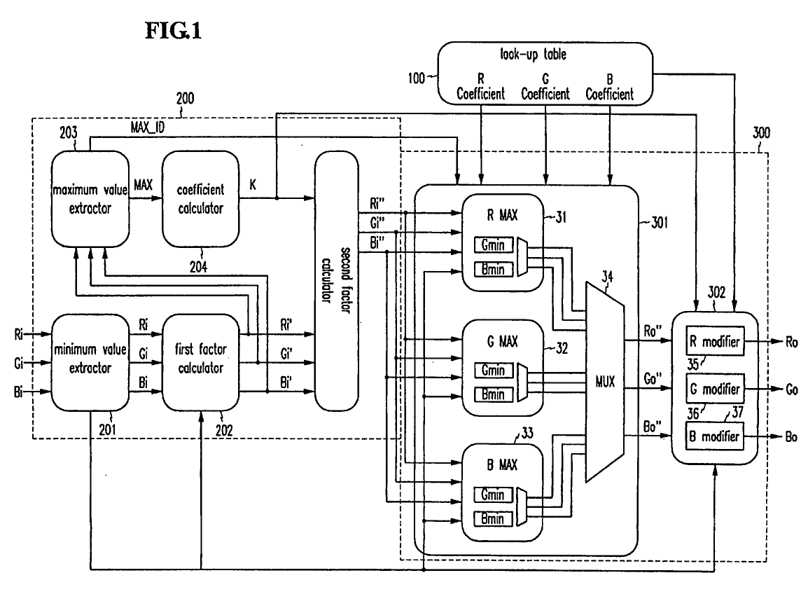

FIG. 1 is a block diagram of a color corrector for a flat panel display according to an embodiment of the present invention.

Referring to FIG. 1, a color corrector for a flat panel display according to an embodiment of the present invention includes a look-up table 100, a coefficient calculating unit 200, and a color correcting unit 300.

The coefficient calculating unit 200 includes a minimum value extractor 201 supplied with image signals Ri, Gi and Bi from an external device and a first factor calculator 202 supplied with the image signals Ri, Gi and Bi from the minimum value extractor 201. The coefficient calculating unit 200 further includes a maximum value extractor 203 supplied with output signals Ri′, Gi′ and Bi′ from the first factor calculator 202, a coefficient calculator 204 supplied with maximum values MAX of the signals Ri′, Gi′ and Bi′ from the maximum value extractor 203, and a second factor calculator 205 supplied with the image signals Ri′, Gi′ and Bi′ and a coefficient K from the first factor calculator 202 and the coefficient calculator 204, respectively.

The color correcting unit 300 includes a multiplexing unit 301 supplied with a minimum information signal MIN_ID from the minimum value extractor 201, a maximum information signal MAX_ID from the maximum value extractor 203, output signals Ri″, Gi″ and Bi″ from the second factor calculator 205, and data from the look-up table 100, and a modifying unit 302 connected to the coefficient calculating unit 200.

The minimum information signal MIN_ID informs which image signal has the lowest value, and the maximum information signal MAX_ID informs which image signal has the highest value.

The multiplexing unit 301 includes first to third multiplexers 31-33 supplied with the output signals Ri″, Gi″ and Bi″ from the second factor calculator 205 of the color correcting unit 300, and a fourth multiplexer 34 for selecting and outputting output signals of the first to the third multiplexers 31-33.

The modifying unit 302 includes a R modifier 35, a G modifier 36, and a B modifier 37 respectively receiving output signals Ro″, Go″ and Bo″ of the multiplexing unit 301, the coefficient K from the coefficient calculator 204 of the coefficient calculating unit 200, and the minimum value (min (Ri, Gi, Bi)) MIN from the minimum value extractor 101, and outputting final corrected image signals Ro, Go and Bo.

Before color correction for input image signals, the gray values on the reference color coordinate of a received standard broadcasting image signals are extracted and compared with the gray values of the reference color coordinate of a flat panel display, and the color coordinates are divided into nine subareas by means of a predetermined areal division method. Each divided subarea is mapped into divisions of different reference color coordinates, and conversion distance information is extracted and stored in the look-up table 100.

The conversion distance information includes a gray value distance for line segments from apexes of the reference color coordinates to points where the gray values become maxima, and a gray value distance for line segments from internal divisions where extensions from white points of color coordinates to the apexes meet the line segments of the reference color coordinates to the apexes of the reference color coordinates.

The color corrector corrects the received standard broadcasting image signals by converting the conversion distance information by means of a predetermined interpolation and outputs the corrected image signals as image signals for driving a flat panel display.

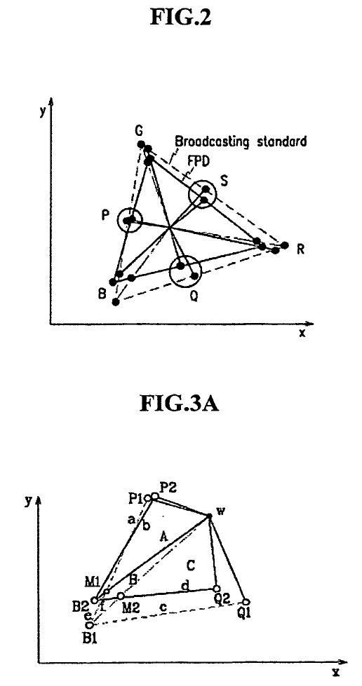

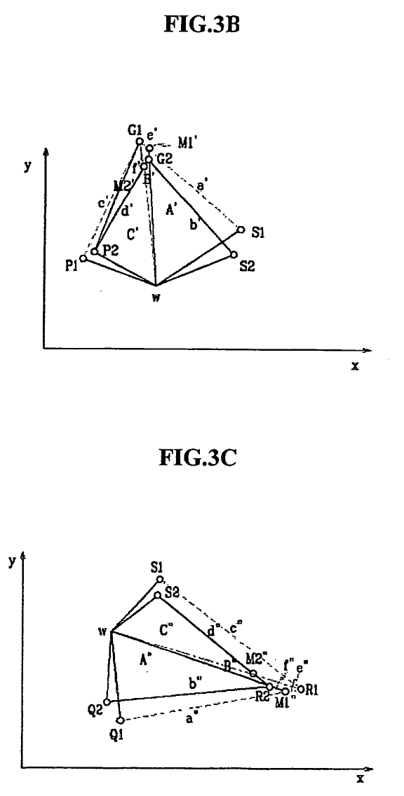

First, a method of dividing a color coordinate into nine subareas according to an embodiment of the present invention with reference to FIGS. 2, 3A, 3B, and 3C.

A method of dividing reference color coordinates of received standard broadcasting image signals and reference color coordinates of a flat panel display into nine subareas first extracts line segments from a white point w of the color coordinates to apexes R, G and B of the reference color coordinates, and line segments from the white points w of the color coordinates to internal divisions M1, M2, M1′, M2′, M1″ and M2″ where extensions from the apexes R, G and B meet the line segments of the reference color coordinates.

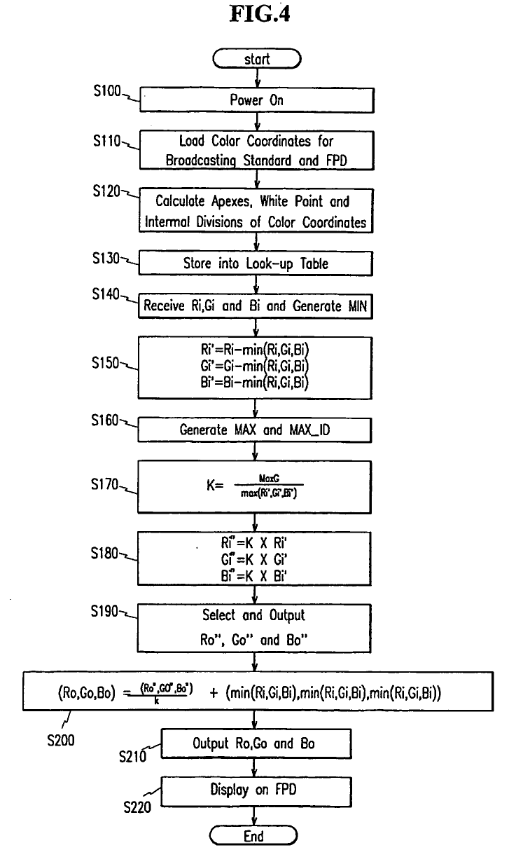

Next, line segments from the white points w of the color coordinates to points P, Q and S where the two gray values become maximum are extracted, and line segments from the points P, Q and S on the color coordinates where the two gray values become maximum to the apexes R, G and B of the reference color coordinates are also extracted. The area of each reference color coordinate is divided into nine subareas having boundaries of the extracted line segments. That is, if the image signals have maxima, three subareas are generated for each signal. For example, FIGS. 3A to 4C show the three divided subareas when the B, G and R image signals has the highest values, respectively, which include some variables introduced for descriptive convenience.

FIG. 3A shows three divided areas when the value of the B image signal is the highest. An area A in the reference color coordinate of the standard broadcasting image signals is defined by apexes w, P1 and M1, and corresponds to an area in the reference color coordinate of the flat panel display defined by apexes w, P2 and B2. Similarly, an area B defined by w, M1 and B1 corresponds to an area w, B2 and M2, and an area C defined by w, B1 and Q1 corresponds to an area w, M2, Q2.

FIG. 3B shows three divided areas when the value of the G image signal is highest. Likewise, an area A′ defined by w, S1 and G1 corresponds to an area w, S2 and G2, an area B′ defined by w, M1′ and G1 corresponds to an area B′ corresponds to an area w, G2 and M2′, and an area C′ defined by w, G1 and P1 corresponds to an area w, M2′ and P2.

FIG. 3C [symbol] shows three divided areas when the value of the B image signal is highest. Similarly, an area A″ defined by w, Q1 and R1 corresponds to an area w, Q2 and R2, an area B″ defined by w, M1″ and R1 corresponds to an area w, R2 and M2″, and an area C″ defined by w, R1 and S1 corresponds to an area w, M2″ and S2.

Here, the internal division M1 is a point where the apexes G1 and B1 are internally divided by m1:n1 (m1>n1), and the internal division M2 is a point where the apexes R2 and B2 are internally divided by m2:n2 (m2>n2). Likewise, the internal division M1′ is a point where the apexes R1 and G1 are internally divided by m1′:n1′ (m1′>n1′), the internal division M2′ is a point where the apexes B2 and G2 are internally divided by m2′:n2′ (m2′>n2′), and the internal division M1″ is a point where the apexes B1 and R1 are internally divided by m1″:n1″ (m1″>n1″). In addition, the internal division M2″ is a point where the apexes G2 and R2 are internally divided by m2″:n2″ (m2″>n2″).

The gray value distances, which are calculated as described above, for the line segments from the internal divisions where the extensions from the white points w of the color coordinates to the apexes meet the line segments of the reference color coordinates to the apexes of the reference color coordinates are calculated as follows. The gray value distance from the internal division M1 to the apex B1 is e, and the gray value distance from the internal division M2 to the apex B2 is f. Furthermore, the gray value distance from the internal division M1′ to the apex G1 is e′, the gray value distance from the internal division M2′ to the apex G2 is f′, and the gray value distance from the internal division M1″ to the apex R1 is e″. The gray value distance from the internal division M2″ to the apex R2 is f″.

In addition, the gray value distances for line segments from the apexes of the reference color coordinates to the points where the two gray values become maxima are calculate as follows. The distances from the apexes B1 and B2 to the maximum gray points P1 and P2 of green and blue colors are a and b, respectively, and the distances from the apexes B1 and B2 to the maximum gray points Q1 and Q2 of red and blue colors are c and d, respectively. The distances from the apexes G1 and G2 to the maximum gray points S1 and S2 of green and red colors are a′ and b′, respectively, and the distances from the apexes G1 and G2 to the maximum gray points P1 and P2 of green and blue colors are c′ and d′, respectively. Moreover, the distances from the apexes R1 and R2 to the maximum gray points Q1 and Q2 of blue and red colors are a″ and b″, respectively, and the distances from the apexes R1 and R2 to the maximum gray points S1 and S2 of green and red colors c″ and d″, respectively.

The values a, b, c, d, e, f, m1, m2, n1 and n2; a′, b′, c′, d′, e′, f′, m1′, m2′, n1′ and n2′; and a″, b″, c″, d″, e″, f″, m1″, m2″, n1″ and n2″ calculated as described above are unique for given reference color coordinates.

FIG. 4 sequentially shows an exemplary color correction for maximum B image signals according to an embodiment of the present invention. That is, the color correction performs color-coordinate conversion of the subareas A, B and C of standard broadcasting image signals into corresponding areas of the reference color coordinate of the flat panel display by means of interpolation, where each reference color coordinate includes three divided areas when the B image signals are maxima.

As shown in FIG. 4, a power switch, etc. is first turned on for operating a flat panel display for displaying TV or video signals (S100), the TV or video signals in standard broadcasting image signals are received, and the gray values on the reference color coordinate for the received image signals are extracted. The color coordinate of the flat panel display having extracted values based on the characteristics of the flat panel display is loaded from hardware such as a memory (S100). NTSC signals, PAL signals or HDTV signals may be received and processed. However, if only one of the above described broadcasting signals is received, a corresponding color coordinate and the color coordinate of the flat panel display are set to predetermined values and automatically loaded whenever power on.

Next, as described above, the gray values for the received reference color coordinate of the standard broadcasting image signals and the reference color coordinate of the flat panel display are compared, and each color coordinate is divided into nine subareas by means of a predetermined areal division method. The divided subareas are mapped into the divisional areas of different reference color coordinate, and a predetermined conversion distance information is extracted (S120). The above described steps are performed only for initial booting when the standard broadcasting signals are alternate to NTSC signals, PAL signals and HDTV signals, or when only one of the broadcasting signals are received. After obtaining the areal division and the conversion distance information, the obtained data are stored in the look-up table 100 (S130).

Thereafter, input image signals Ri, Gi and Bi are real-time signal-converted by using interpolation.

When the B image signals are maxima, the areas A, B and C among the nine subareas are used, and the variables a, b, c, d, e, f, m1, m2, n1 and n2 among the obtained variables are used.

From the above-described application variables, the color corrector converts the areas A, B and C into the corresponding areas of the reference color coordinate of the flat panel display by using interpolation based on the above-described conversion distance information, thereby correcting the received standard broadcasting image signals. This operation is described with reference to FIG. 2.

First, the minimum value extractor 201 of the coefficient calculating unit 200 receives image signals Ri, Gi and Bi in broadcasting standard, extracts the minimum value of the image signals Ri, Gi and Bi, and generates the minimum value information signal MIN_ID and the minimum value min(Ri,Gi,Bi) MIN (S140). Subsequently, the first factor calculator 202 calculates Ri′, Gi′ and Bi′ based on Equation 1 for the coordinate values of the image signals Ri, Gi and Bi by using the minimum value MIN from the minimum value extractor 201 and the image signals Ri, Gi and Bi from the minimum value extractor 201 (S150).
(Ri′, Gi′, Bi′)=(Ri−min(Ri,Gi,Bi), Gi−min(Ri,Gi,Bi)−min(Ri,Gi,Bi)). (1)

Subsequently, the maximum value extractor 203 extracts the maximum value (max(Ri′, Gi′, Bi′)) MAX from the output signals Ri′, Gi′ and Bi′ of the first factor calculator 202 and provides the extracted maximum values for the coefficient calculator 204 and maximum value information signal MAX_ID for the color correcting unit 300 (S160).

The coefficient calculator 204 calculates the coefficient K using Equation 2 (S170).

$$K = \frac{Max G}{max ( {Ri}^{′} , {Gi}^{′} , {Bi}^{′} )} . \qquad ( 2 )$$

Next, the second factor calculator 205 calculates (Ri″, Gi″, Bi″) based on the coefficient K using Equation 3(S180).
(Ri″, Gi″, Bi″)=(K×Ri′, K×Gi′, K×Bi′). (3)

The converted value Ri″, Gi″ and Bi″ include 0, the maximum gray, and a number t which is neither 0 nor the maximum gray.

Subsequently, one of the first to third the multiplexers 31-33 in the multiplexing unit 301 of the color correcting unit 300 is selected to be enabled based on the minimum value information signal MIN_ID from the minimum value extractor 201 and the maximum value information signal MAX_ID from the maximum value extractor 203.

A data in the look-up table 100 corresponding to a signal among the signals Ri″, Gi″ and Bi″ which has neither the maximum value MAX nor the minimum value MIN is supplied to the enabled multiplexer 31-33.

One among the converted values Ro″, Go″ and Bo″ except for “0” and “the maximum gray” is already stored in the look-up table 100, which is calculated by using one of Eqs. 4, 5 and 6, for the gray values on the corresponding areas for the nine subareas depending on t forming the converted values Ri″, Gi″ and Bi″,

$$\{ t - Max G \times \frac{n1}{m1 + n1} \} \times \frac{b}{a} , \qquad ( 4 )$$

where t is a number among Ri″, Gi″ and Bi″ except for 0 and the maximum gray, and m1, n1, a and b are the predetermined conversion distance information;

$$t \times \frac{f}{e} , \qquad ( 5 )$$

where t is a number among Ri″, Gi″ and Bi″ except for 0 and the maximum gray, and e and f are the predetermined conversion distance information; and

$$t \times \frac{c}{b} + Max G \times \frac{n2}{m2 + n2} , \qquad ( 6 )$$

where t is a number among Ri″, Gi″ and Bi″ except for 0 and the maximum gray, and a, b, m2 and n2 are the predetermined conversion distance information.

The data depending on t determined by the maximum value information signal MAX-ID and the minimum value information signal MIN_ID is selected in the look-up table 100 by a controller (not shown) and provided for the multiplexers 31-33, and the multiplexer 34 outputs the signals Ro″, Go″ and Bo″ from the enabled multiplexer 31-33 (S190).

Accordingly, the output signals Ro″, Go″ and Bo″ from the multiplexer 34 include “0”, “MaxG” and a data for t already stored in the look-up table 100.

Subsequently, the modifiers 35-37 of the modifying unit 302 calculate and output the final gray values Ro, Go and Bo for the R, G and B image signals for driving the flat panel display, respectively, based on Eq. 7 in Table 1 (S200 and S210).

$$( Ro , Go , Bo ) = \frac{( {Ro}^{″} , {Go}^{″} , {Bo}^{″} )}{K} + ( min ( Ri , Gi , Bi ) , min ( Ri , Gi , Bi ) , min ( Ri , Gi , Bi ) ) . \qquad ( 7 )$$

After the image signals Ri, Gi and Bi in broadcasting standard from the color corrector are corrected into the image signals Ro, Go and Bo for the flat panel display as described above, the image signals Ro, Go and Bo are processed by a signal controller such that they are suitable for the characteristics of the flat panel display such as the configuration and the resolution, thereby driving the display panel (S220).

The above-described interpolation is also applied to the areas A′, B′ and C′ when the G image signal is highest and the areas A″, B″ and C″ when the R image signal is highest. That is, the variables a′, b′, c′, d′, e′, f′, m1′, m2′, n1′ and n2′ for the areas A′, B′ and C′ and the variables a″, b″, c″, d″, e″, f″, m1″, m2″n, n1″ and n2″ for the areas A″, B″ and C″ are inserted into Eq. 1 to Eq. 7 to convert the standard broadcasting image signals Ri, Gi and Bi to the image signals Ro, Go and Bo for driving flat panel display.

For example, it is assumed that standard broadcasting image signals Ri, Gi and Bi inputted into a flat panel display displaying 256 grays (i.e., the 0th to the 255th grays) are 2, 4 and 7, respectively. The gray values of the input image signals Ri, Gi and Bi belong to the area A, and thus (Ri′, Gi′, Bi′)=(0, 2, 5), K=255/5, (Ri″, Gi″, Bi″)=(0, 510/5, 255), t=510/5, (Ro″, Go″, Bo″)=(0, {510/5−255×n1/(m1+n1)}×b/a, 255) are calculated from equations. Accordingly, the converted data (Ro, Go, Bo)=(0, {2−5×n1/(m1+n1)}×b/a, 5) are obtained.

TABLE 1

| | Area with | Area with | Area with |
|---|---|---|---|
| | Maximum B Gray | Maximum C Gray | Maximum R Gray |
| Gray of | (Ri, Gi, Bi) | (Ri, Gi, Bi) | (Ri, Ci, Bi) |
| Input Signal | | | |
| Variable | a, b, c, d, e, f | a′, b′, c′, d′, e′, f′ | a″, b″, c″, d″, e″, f″ |
| | m1, n1, m2, n2 | m1′, n1′, m2′, n2′ | m1″, n1″, m2″, n2″ |
| Eq. 1 | (Ri′, Gi′, Bi′) = (Ri − min(Ri, Gi, Bi), | | |
| | Gi − min(Ri, Gi, Bi), | | |
| | Bi − min(Ri, Gi, Bi)) | | |
| Eq. 2 | $K = \frac{MaxG}{max ( {Ri}^{′} , {Gi}^{′} , {Bi}^{′} )}$ | | |
| Eq. 3 | (Ri″, Gi″, Bi″) = (K × Ri′, K × Gi′, K × Bi′) | | |
| Eq. 4 | t = number among Ri″, Gi″ and Bi″ except for 0 and MaxG | | |
| | Area A | Area A′ | Area A″ |
| Ro″ = | 0 | $\{ t - MaxG \times \frac{{n1}^{′}}{{m1}^{′} + {n1}^{′}} \} \times \frac{{b}^{′}}{{a}^{′}}$ | MaxG |
| Go″ = | $\{ t - MaxG \times \frac{n1}{m1 + n1} \} \times \frac{b}{a}$ | MaxG | 0 |
| Bo″ = | MaxG | 0 | $\{ t - MaxG \times \frac{{n1}^{″}}{{m1}^{″} + {n1}^{″}} \} \times \frac{{b}^{″}}{{a}^{″}}$ |
| Eq. 5 | Area B | Area B′ | Area B″ |
| Ro″ = | $t \times \frac{f}{e}$ | 0 | MaxG |
| Go″ = | 0 | MaxG | $t \times \frac{{f}^{′}}{{e}^{″}}$ |
| Bo″ = | MaxG | $t \times \frac{f}{{e}^{′}}$ | 0 |
| Eq. 6 | Area B | Area B′ | Area B″ |
| Ro″ = | $t \times \frac{c}{b} + MaxG \times \frac{n2}{m2 + n2}$ | 0 | MaxG |
| Go″ = | 0 | MaxG | $t \times \frac{{c}^{″}}{{b}^{″}} + MaxG \times \frac{{n2}^{″}}{{m2}^{″} + {n2}^{″}}$ |
| Bo″ = | MaxG | $t \times \frac{{c}^{′}}{{b}^{′}} + MaxG \times \frac{{n2}^{′}}{{m2}^{′} + {n2}^{′}}$ | 0 |

| | |
|---|---|
| Eq. 7 | $\begin{matrix}( Ro , Go , Bo ) = \frac{( {Ro}^{″} , {Go}^{″} , {Bo}^{″} )}{K} + \\ ( min ( Ri , Gi , Bi ) , min ( Ri , Gi , Bi ) , min ( Ri , Gi , Bi ) )\end{matrix}$ |

Accordingly, the flat panel display according to the embodiments of the present invention displays standard broadcasting image signals with color reproductivity to a maximum color range that the flat panel display can reproduce but without distorting colors.

While the present invention has been described in detail with reference to the preferred embodiments, those skilled in the art will appreciate that various modifications and substitutions can be made thereto without departing from the spirit and scope of the present invention as set forth in the appended claims.

What is claimed is:

1. A color corrector of a flat panel display, comprising:
a look-up table storing a plurality of conversion distance information obtained by matching nine divided subareas for color coordinates of received image signals with divided subareas for reference color coordinates and corrected values for the image signals; and
a color correction unit converting the image signals by converting the conversion distance information by using interpolation, and extracting the corrected values depending on the converted image signals to correct the image signals.

2. A method of color correction for a flat panel display using a color corrector of the flat panel display for correcting image signals in broadcasting standard into image signal for driving the flat panel display, the method comprising:
(a) extracting gray values for apexes on reference color coordinates for received image signals;
(b) comparing the gray values for the reference color coordinates of the standard broadcasting image signals and the reference color coordinates of the flat panel display, diving the color coordinates into nine subareas using an areal division, matching the divided subareas with divisional areas of the reference color coordinates, and extracting a conversion distance information; and
(c) correcting the received standard broadcasting image signals by converting the conversion distance information using interpolation, and outputting image signals for driving the flat panel display.

3. The method of claim 2, wherein the areal division comprises:
(d) extracting line segments from a white point of the color coordinate to apexes of the reference color coordinates, and line segments from the white point of the color coordinate to internal divisions where extensions from the apexes meet the line segments of the reference color coordinates;
(e) extracting line segments from the white point of the color coordinates to points where the two gray values become maximum;
(f) extracting line segments from the points P, Q and S on the color coordinates where the two gray values become maximum to the apexes R, G and B of the reference color coordinates; and
(g) dividing the area of each reference color coordinate into the nine subareas having boundaries of the extracted line segments.

4. The method of claim 2, wherein the conversion distance information includes a gray value distance for line segments from apexes of the reference color coordinates to points where the gray values become maximum, and a gray value distance for line segments from internal divisions where extensions from white points of color coordinates to the apexes meet the line segments of the reference color coordinates to the apexes of the reference color coordinates.

5. The method of claim 2, wherein the interpolation comprises:
(h-1) calculating Ri′, Gi′ and Bi′ for the coordinate values of the image signals Ri, Gi and Bi using an equation:
(Ri′, Gi′, Bi′)=(Ri−min(Ri,Gi,Bi), Gi−min(Ri,Gi,Bi)−min(Ri,Gi,Bi));
(h-2) calculating K using an equation:
$$K = \frac{Max G}{max ( {Ri}^{′} , {Gi}^{′} , {Bi}^{′} )} ;$$
(h-3) calculating converted values Ri″, Gi″ and Bi″ using an equation:
(Ri″, Gi″, Bi″)=(K×Ri′, K×Gi′, K×Bi′),
where the converted value Ri″, Gi″ and Bi″ include 0, the maximum gray, and a number t which is neither 0 nor the maximum gray.
(h-4) calculating converted values Ro″, Go″ and Bo″ including 0, the maximum gray and a value for the gray values on the corresponding areas for the nine subareas depending on t forming the converted values Ri″, Gi″ and Bi″, the value obtained by one among:
$$\{ t - Max G \times \frac{n1}{m1 + n1} \} \times \frac{b}{a} , \qquad ( 4 )$$
where t is a number among Ri″, Gi″ and Bi″ except for 0 and the maximum gray, and m1, n1, a and b are the predetermined conversion distance information;
$$t \times \frac{f}{e} , \qquad ( 5 )$$
where t is a number among Ri″, Gi″ and Bi″ except for 0 and the maximum gray, and e and f are the predetermined conversion distance information; and
$$t \times \frac{c}{b} + Max G \times \frac{n2}{m2 + n2} , \qquad ( 6 )$$
where t is a number among Ri″, Gi″ and Bi″ except for 0 and the maximum gray, and a, b, m2 and n2 are the predetermined conversion distance information; and
(h-5) calculating the gray values Ro, Go and Bo of the image signals for driving the flat panel display using an equation:
$$( Ro , Go , Bo ) = \frac{( {Ro}^{″} , {Go}^{″} , {Bo}^{″} )}{K} + ( min ( Ri , Gi , Bi ) , min ( Ri , Gi , Bi ) , min ( Ri , Gi , Bi ) ) .$$
